(19) United States
(12) Patent Application Publication
(10) Pub. No.: US 2025/0211550 A1
(43) Pub. Date: Jun. 26, 2025

(54) GENERATING DIALOGUE FLOWS FROM UNLABELED CONVERSATION DATA USING LANGUAGE MODELS

(71) Applicant: NVIDIA CORPORATION, Santa Clara, CA (US)

(72) Inventors: Makesh Narsimhan SREEDHAR, Santa Clara, CA (US); Christopher Marc PARISIEN, Toronto (CA); Traian-Eugen REBEDEA, Bucharest (RO)

(21) Appl. No.: 18/393,439

(22) Filed: Dec. 21, 2023

(51) Int. Cl. H04L 51/02; G06F 16/901; G06F 40/35

(52) U.S. Cl. CPC H04L 51/02; G06F 16/9024; G06F 40/35

(57) ABSTRACT

In various examples, a technique for generating dialogue flows includes inputting a plurality of conversations into a machine learning model. The technique also includes generating, based at least on the machine learning model processing the plurality of conversations, a plurality of annotations comprising a plurality of constrained semantic representations for respective messages of sequences of messages included in the plurality of conversations. The technique further includes generating one or more dialogue flows from the plurality of constrained semantic representations and causing a conversational output to be generated based on the one or more dialogue flows.

### TECHNICAL FIELD

Embodiments of the present disclosure relate generally to natural language processing and machine learning and, more specifically, to techniques for generating dialogue flows from unlabeled conversation data.

### BACKGROUND

Dialogue policies, or dialogue flows, refer to instructions or policies for guiding conversations between chatbots and users. For example, a dialogue flow may be used to guide interactions related to task-oriented applications such as customer service, where a chatbot navigates through a structured conversation to assist with inquiries or problems. During a given interaction, the dialogue flow may direct a chatbot to request information from a user, provide instructions to the user, and/or carry out other operations with the goal of moving the conversation towards a resolution or a desired outcome.

Traditionally, dialogue flows have been constructed via a resource-intensive design process involving conversation designers, data scientists, and/or other domain experts. During this design process, the domain experts analyze existing conversations to construct user intents, responses, and common pathways included in the dialogue flows. While computer-based tools are available to assist with this design process, these tools do not obviate the need for human expertise and effort in developing dialogue flows that address complex and diverse user needs.

More recently, machine learning techniques have been developed to assist in the generation of dialogue flows. These techniques commonly involve “process mining,” which uses sets of predefined labels to extract information from conversations. However, these predefined labels are manually defined for a given type of interaction, which limits the type of information that can be extracted. Consequently, these techniques also involve manual effort and expertise and cannot be easily adapted or scaled to accommodate interactions across a variety of domains and/or scenarios.

As the foregoing illustrates, what is needed in the art are more effective techniques for generating dialogue flows.

### BRIEF DESCRIPTION OF DRAWINGS

FIG. 1 illustrates a block diagram of a computing system configured to implement one or more aspects of at least one embodiment;

FIG. 2 is a more detailed illustration of the annotation engine, dialogue engine, and execution engine 126 of FIG. 1, according to at least one embodiment;

FIG. 3 illustrates example training data that can be used to train a machine learning model by the annotation engine of FIG. 1, according to at least one embodiment;

FIG. 4A illustrates example training input for the machine learning model of FIG. 2, according to at least one embodiment;

FIG. 4B illustrates example training output associated with the training input of FIG. 4A, according to at least one embodiment;

FIG. 5A illustrates an example set of conversations that can be annotated by the annotation engine of FIG. 1, according to at least one embodiment;

FIG. 5B illustrates the example conversations of FIG. 5A that have been annotated with canonical forms, according to at least one embodiment;

FIG. 5C illustrates an example graph that is constructed from the canonical forms of FIG. 5B, according to at least one embodiment;

FIG. 5D illustrates an example dialogue flow that can be generated from the graph of FIG. 5C, according to at least one embodiment;

FIG. 6 illustrates a flow diagram of a method for generating a dialogue flow, according to at least one embodiment;

FIG. 7A illustrates inference and/or training logic, according to at least one embodiment;

FIG. 7B illustrates inference and/or training logic, according to at least one embodiment; and

FIG. 8 illustrates training and deployment of a neural network, according to at least one embodiment.

### DETAILED DESCRIPTION

As discussed herein, dialogue flows have traditionally been constructed via resource-intensive processes that require domain expertise and manual effort. While machine learning techniques have been developed more recently to assist in the generation of dialogue flows, these techniques typically use manually predefined labels to extract information from conversations and cannot be easily adapted or scaled to accommodate interactions across a variety of domains and/or scenarios.

To address the above limitations, the disclosed techniques use a machine learning model, such as a large language model (LLM) and/or generative model, to automatically create dialogue flows for various types of conversation-based tasks and/or domains. The machine learning model is fine-tuned using a small set of conversations that have been manually annotated with canonical forms for messages from both users and chatbots. These canonical forms can include (but are not limited to) summarizations, short descriptions, and/or intent definitions related to messages in the conversations and/or actions performed in association with the messages. After fine-tuning is complete, the machine learning model is capable of generalizing to other types of tasks and/or domains.

More specifically, the fine-tuned machine learning model is used to annotate a larger dataset of conversations with the corresponding canonical forms. For example, the fine-tuned machine learning model may be used to convert a sequence of messages within each conversation into a corresponding sequence of canonical forms. The fine-tuned machine learning model may also, or instead, be used to append a canonical form to the end of each message within the sequence.

Next, a graph is constructed from the annotated conversations. Within the graph, nodes represent canonical forms (which may correspond to generalized intents, tasks, actions, etc., each of which may be represented as a vector embedding in an embedding/latent space), and directed edges represent orderings of messages annotated with the canonical forms within the conversations. Each edge may also be associated with a weight representing a frequency of occurrence and/or another measure of relative importance or prominence.

Various graph analysis techniques may then be used to extract paths representing different types of dialogue flows. For example, a path that includes edges with the highest weights may be used as a “default” or “principal” dialogue flow for a particular type of task. Additional paths that branch off the default path may be used as (e.g., secondary) dialogue flows for other types of tasks—such as issue resolution, digressions, and/or other scenarios. The extracted dialogue flows may then be incorporated into chatbot runtimes, tested, and/or refined.

One technical advantage of the disclosed techniques relative to prior approaches is the ability to automatically generate dialogue flows from sets (e.g., including as little as 20 to 30 conversations) of unlabeled conversations. The disclosed techniques are thus more efficient and less resource-intensive than conventional approaches that involve manual generation of dialogue flows and/or labels for process mining dialogue flows. Another technical advantage of the disclosed techniques is the ability to extract, from the unlabeled conversations, various paths that can be used to perform different types of tasks and/or address various issues associated with the tasks. Consequently, the disclosed techniques can be used to generate more flexible and comprehensive dialogue flows than existing approaches that are limited in the ability to generate dialogue flows for different domains and/or scenarios.

The above examples are not in any way intended to be limiting. As persons skilled in the art will appreciate, as a general matter, the techniques for automatically generating dialogue flows from unlabeled conversation data can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as LLMs that may process text, audio, and/or image data, systems for performing light transport simulation, systems for performing collaborative content creation for 3D assets, systems implemented at least partially using cloud computing resources, systems for performing generative AI operations, and/or other types of systems.

### System Overview

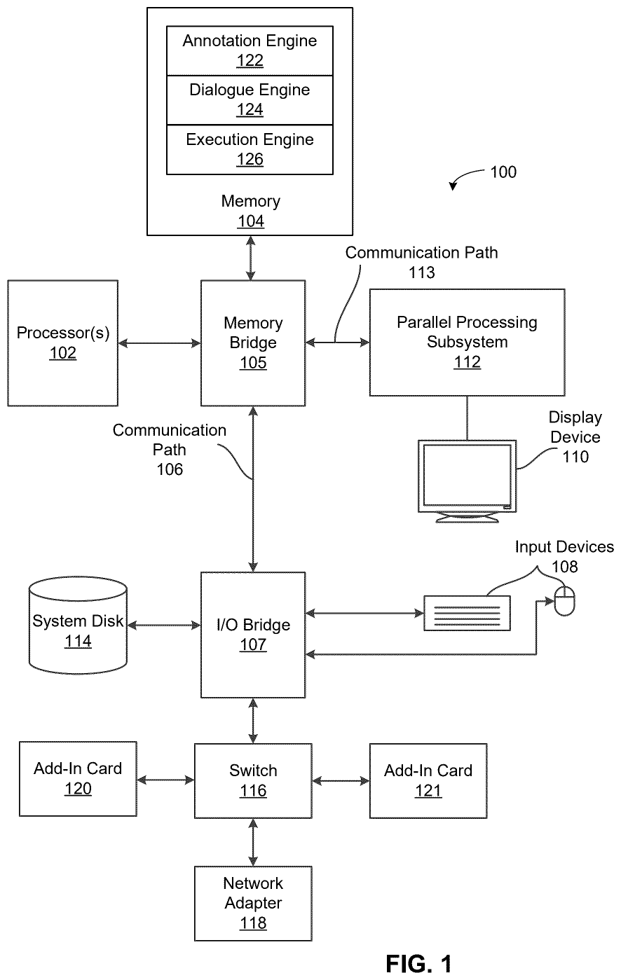

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include an annotation engine 122, a dialogue engine 124, and an execution engine 126, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

In some embodiments, annotation engine 122, dialogue engine 124, and execution engine 126 include functionality to automatically create dialogue flows for various types of conversation-based tasks and/or domains. Annotation engine 122 trains and/or fine-tunes a machine learning model using a small (or large, depending on the implementation) set of conversations that have been manually annotated with canonical forms for messages from both users and chatbots. These canonical forms can include (but are not limited to) summarizations, short descriptions, and/or intent definitions related to messages in the conversations and/or actions performed in association with the messages. After fine-tuning is complete, annotation engine 122 uses the machine learning model to annotate a larger dataset of conversations with the corresponding canonical forms.

Dialogue engine 124 constructs a graph from annotated conversations generated by annotation engine 122. Within the graph, nodes represent canonical forms, and directed edges represent orderings of messages labeled with the canonical forms within the conversations. Each edge may also be associated with a weight representing a frequency of occurrence and/or another measure of relative importance or prominence.

Dialogue engine 124 also uses various graph analysis techniques to extract paths representing different types of dialogue flows. For example, a path that includes edges with the highest weights may be used as a “default” dialogue flow for a particular type of task. Additional paths that branch off the default path may be used as dialogue flows for other types of tasks, issue resolution, digressions, and/or other scenarios.

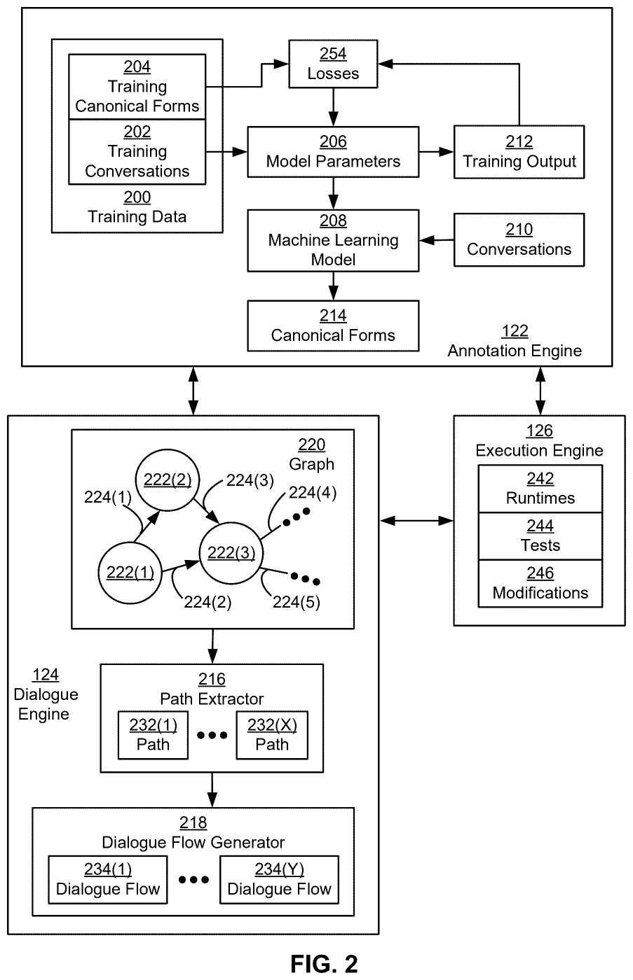

Execution engine 126 incorporates the extracted dialogue flows from dialogue engine 124 into various environments and/or applications. These environments and/or applications may include (but are not limited to) chatbot runtimes, test environments, and/or user interfaces for analyzing and refining the dialogue flows. Annotation engine 122, dialogue engine 124, and execution engine 126 are described in further detail below with respect to FIGS. 2-6.

Automatically Generating Dialogue Flows from Unlabeled Conversation Data

FIG. 2 is a more detailed illustration of annotation engine 122, dialogue engine 124, and execution engine 126 of FIG. 1, according to at least one embodiment. As discussed herein, annotation engine 122, dialogue engine 124, and execution engine 126 are configured to automatically create and execute dialogue flows 234(1)-234(Y) for various types of conversation-based tasks and/or domains.

Annotation engine 122 uses a machine learning model 208 to annotate one or more conversations 210 with canonical forms 214. In some embodiments, conversations 210 include text-based transcripts of interactions between a user and one or more other entities (e.g., a different user, a chatbot, an agent or representative, a virtual character, etc.). For example, a given conversation may include a transcript of a text-based chat; a recording and/or transcript of a meeting, call, press conference, and/or another type of interaction; a script from a film, television show, or play; and/or another representation of an interaction between the user and the other entity (or entities). The conversation may include a sequence of chat messages, utterances, and/or other units of communication generated by the user and the other entity (or entities). Each unit of communication may be prefaced with an identifier for the corresponding participant (e.g., the user, a chatbot, etc.).

In one or more embodiments, canonical forms 214 include constrained semantic representations (e.g., summarizations, short descriptions, intent definitions, etc.) of the natural language of text, such as the text of a user input or text outputted by a chatbot and/or language model. For example, a given canonical form may correspond to a “standardized” form of the semantic meaning of a portion of text.

As shown in FIG. 2, annotation engine 122 trains and/or fine-tunes machine learning model 208 using training data 200 that includes a set of training conversations 202 that have been labeled with the corresponding training canonical forms 204. As with conversations 210, training conversations 202 include transcripts of chats, recordings, and/or other types of interactions between users and other entities. Training canonical forms 204 include standardized forms of intents and/or semantic meanings for chat messages, utterances, and/or other text segments in training conversations 202.

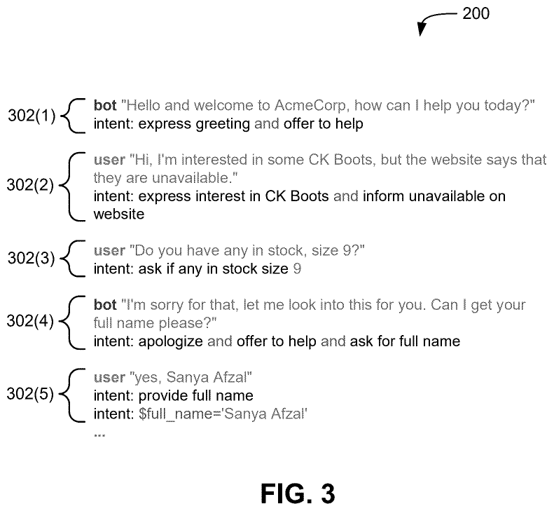

FIG. 3 illustrates example training data 200 that can be used to train machine learning model 208 by annotation engine 122 of FIG. 1, according to at least one embodiment. As shown in FIG. 3, the example training data 200 includes a number of annotated message 302(1)-302(5), each of which is referred to individually herein as annotated message 302.

Each annotated message 302 includes a first portion that specifies a participant. For example, the first portion of each annotated message 302 may begin with identifying a participant as a “bot” or a “user.”

The first portion of each annotated message 302 also includes an utterance made by the identified participant. For example, annotated message 302(1) includes an utterance of “Hello and welcome to AcmeCorp, how can I help you today?” for the “bot” participant. Annotated message 302(2) includes an utterance of “Hi, I'm interested in some CK Boots, but the website says that they are unavailable” that is made by the “user” participant after the user has received the utterance of “Hello and welcome to AcmeCorp, how can I help you today?” from the “bot” participant.

Each annotated message 302 also includes an “intent” that specifies one or more canonical forms associated with the utterance. For example, annotated message 302(1) includes two canonical forms of “express greeting” and “offer to help.” Annotated message 302(2) includes two canonical forms of “express interest in CK Boots” and “inform unavailable on website.”

In one or more embodiments, some or all training data 200 is generated by manually annotating a set of training conversations 202 with the corresponding training canonical forms 204. For example, a larger set of conversations (e.g., conversations 210) may be divided into different categories, groups, or clusters of conversations (e.g., based on predefined categories of conversations, sources of the conversations, embeddings of the conversations, output from a classifier, etc.), and a certain number or proportion of training conversations 202 may be sampled from each category, group, or cluster. Individual utterances in training conversations 202 may then be labeled with the corresponding training canonical forms 204 by one or more users.

Returning to the discussion of FIG. 2, machine learning model 208 may include a neural network and/or another type of model that is capable of generating annotations of text (or other types of content). For example, machine learning model 208 may include a pre-trained large language model (LLM) and/or generative model that is capable of processing and/or outputting text, audio, images, and/or other data types. As such, in some embodiments, in addition to providing textual conversation data to the machine learning model 208 (for training and/or inference), the system may also train the model on images, audio, and/or other types of data that the machine learning model 208 is configured or capable of processing. As an example, where the dialogue flow or policy is being created for a shoe company, the conversation data may include the textual information as well as images provided by the user and/or bot that depict shoes of interest to the user or shoes recommended to the user by the bot.

During training and/or fine-tuning of machine learning model 208, annotation engine 122 may input training conversations 202 into machine learning model 208. Annotation engine 122 also uses model parameters 206 (e.g., neural network weights) of machine learning model 208 to process the inputted training conversations 202 and obtains training output 212 that includes predictions of canonical forms for the inputted training conversations 202 from one or more layers, blocks, or components of machine learning model 208. Annotation engine 122 computes one or more losses 254 (e.g., cross entropy loss, triplet loss, sequence loss, etc.) between training output 212 and the corresponding training canonical forms 204. Annotation engine 122 then uses a training technique (e.g., gradient descent and backpropagation, low rank adaptation, etc.) to iteratively update model parameters 206 of machine learning model 208 in a way that reduces losses 254.

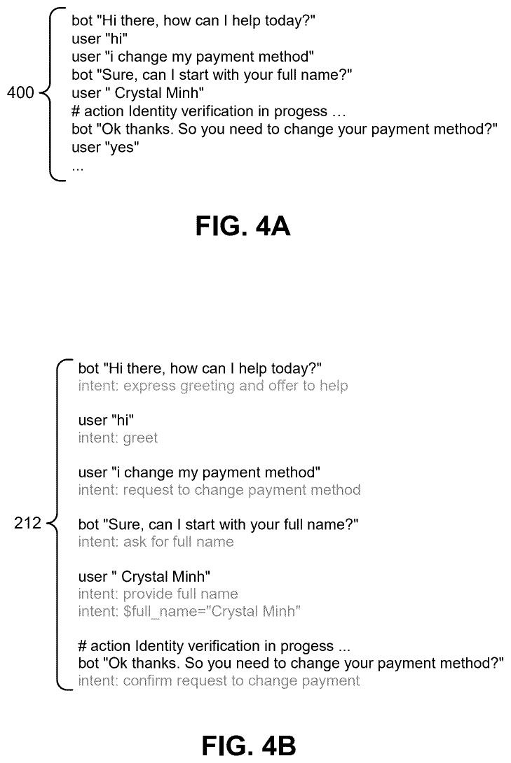

FIG. 4A illustrates example training input 400 for machine learning model 208 of FIG. 2, according to at least one embodiment. As shown in FIG. 4A, the example training input 400 includes a training conversation (e.g., from training conversations 202) corresponding to a textual representation of an interaction between a “user” and a “bot.” The interaction includes a series of messages from the user and bot, as well as an “action” that is triggered by the bot.

FIG. 4B illustrates example training output 212 associated with training input 400 of FIG. 4A, according to at least one embodiment. As shown in FIG. 4B, the example training output 212 includes messages from training input 400, with each message followed by one or more corresponding canonical forms that denote the intent of the message. To generate training output 212, machine learning model 208 may be used to convert one or more portions of training input 400 (e.g., individual utterances, a subset of utterances in the training conversation, the entire training conversation, etc.) into one or more corresponding portions of training output 212. For example, machine learning model 208 may be configured to generate, from a sequence of one or more inputted utterances, output that includes the same utterance(s) and annotations of the utterance(s) with the corresponding canonical forms. Machine learning model 208 may also, or instead, be configured to generate, from the sequence of inputted utterance(s), output that omits the inputted utterance(s) and includes a sequence of canonical forms representing the sequence of inputted utterance(s).

One or more losses 254 may be computed as differences between training output 212 and training canonical forms 204 for utterances in training input 400. Machine learning model 208 may then be trained using losses 254 so that subsequent training output 212 generated by machine learning model 208 from inputted training conversations 202 more accurately reflects the corresponding training canonical forms 204.

Returning to the discussion of FIG. 2, after machine learning model 208 is trained and/or fine-tuned using training conversations 202 and training canonical forms 204 in training data 200, machine learning model 208 can be used to annotate additional conversations 210 related to other types of tasks and/or domains with the corresponding canonical forms 214. For example, annotation engine 122 may input conversations 210 that were not included in training data 200 into the trained and/or fine-tuned machine learning model 208. Annotation engine 122 may also obtain, as output of machine learning model 208, canonical forms 214 for individual utterances in the inputted conversations 210. Consequently, annotation engine 122 may be used to annotate a large corpus of conversations 210 with canonical forms 214 using a relatively small amount of training data 200.

Dialogue engine 124 generates a graph 220 using sequences of canonical forms 214 generated by annotation engine 122 from the corresponding conversations 210. Graph 220 may optionally also be generated using sequences of training canonical forms 204 from training data 200 (e.g., for more complete coverage of variations in the corresponding interactions, tasks, domains, and/or scenarios). Graph 220 includes a number of nodes 222(1)-222(3) (each of which is referred to individually herein as node 222) and a number of directed edges 224(1)-224(5) (each of which is referred to individually herein as edge 224) between pairs of nodes 222.

In some embodiments, each node 222 included in graph 220 represents a different canonical form, and each edge 224 from a first node 222 to a second node 222 represents an ordering or transition from a first canonical form represented by the first node 222 to a second canonical form represented by the second node 222 within conversations 210. A given node 222 representing a canonical form may optionally be annotated with an action that is performed (e.g., verifying the identity of a user, performing or cancelling a transaction, performing a lookup, transmitting an email, generating an alert or notification, etc.) in conjunction with the canonical form. A given node 222 may also, or instead, represent a standalone action, with a relationship between the action and an associated intent represented by a directed edge 224 from another node representing the intent to the node representing the action.

Prior to generating graph 220, dialogue engine 124 may optionally use one or more clustering techniques to generate groupings of semantically related and/or similar canonical forms 214. Dialogue engine 124 may then generate a different node 222 for each canonical form (or grouping of canonical forms 214). Next, dialogue engine 124 may connect nodes 222 with edges 224 representing orderings of the corresponding canonical forms 214 (or groupings of canonical forms 214) within conversations 210. Dialogue engine 124 may further assign a weight to each edge 224 representing the frequency of the corresponding ordering of canonical forms 214 (or grouping of canonical forms 214) within conversations 210.

After graph 220 is generated, a path extractor 216 in dialogue engine 124 extracts a number of paths 232(1)-232(X) (each of which is referred to individually herein as path 232) from graph 220. Each path 232 represents a sequence of canonical forms 214 that can be used to perform a task and/or handle a different scenario.

For example, path extractor 216 may use path finding techniques to identify, within a given graph 220 that is generated from conversations 210 for carrying out a certain task or set of tasks, a single path 232 that represents the most frequent sequence of canonical forms 214 (or groupings of canonical forms 214) within these conversations 210. Path extractor 216 may denote this path 232 as a “main,” “principal,” or “default” path 232 within conversations 210. Path extractor 216 may also, or instead, find alternative paths 232 representing regularly occurring deviations from the main or default path 232. These alternative or secondary paths 232 may include sequences of canonical forms 214 (or groupings of canonical forms 214) that are used to handle other types of tasks, issues, digressions, and/or other scenarios. Path extractor 216 may also, or instead, identify one or more shortest paths 232 between a given starting node 222 (e.g., a node with no incoming edges) in graph 220 and a corresponding ending node 222 (e.g., a node with no outgoing edges) in graph 220. These shortest paths 232 may represent the most efficient sequences of canonical forms 214 (or groupings of canonical forms 214) for handling various scenarios that begin at the canonical form represented by the starting node 222 and end at the canonical form represented by the ending node 222. Path extractor 216 may also, or instead, identify one or more shortest paths 232 and/or one or more most frequent paths 232 between a first node 222 and a second node 222. The first and second nodes 222 may be specified by a user, identified by a machine learning model (e.g., machine learning model 208, an LLM, a generative model, a classifier, etc.) as representing important steps or points in performing one or more tasks, and/or determined using other techniques.

In another example, path extractor 216 may use one or more parametric graph analysis techniques (e.g., graph neural networks) to summarize graph 220, in lieu of or in addition to clustering of canonical forms 214 prior to generating graph 220. Path extractor 216 may also, or instead, use these parametric graph analysis techniques to extract various types of paths 232 (e.g., a most frequent path, regularly occurring paths that branch off the most frequent path, a shortest path between two canonical forms, etc.) from graph 220 and/or the summarized version of graph 220.

A dialogue flow generator 218 in dialogue engine 124 converts paths 232 into a number of dialogue flows 234(1)-234(Y) (each of which is referred to individually herein as dialogue flow 234). Each dialogue flow 234 includes instructions for guiding conversations, tasks, and/or scenarios involving a user and one or more other entities (e.g., a chatbot, another user, an agent or representative, a technician, a virtual character, etc.).

In one or more embodiments, each dialogue flow 234 includes one or more sequences of steps corresponding to one or more paths 232 extracted from graph 220. The sequence(s) may be represented as a canonical form input or output and one or more associated next steps. For example, a given dialogue flow 234 may include a canonical form input (e.g., “user express greeting”) and a canonical form output to be generated in response to the canonical form input (e.g., “bot express greeting”). In another example, a given dialogue flow 234 may include a canonical form input or output and multiple next steps that include (but are not limited to) executing actions, branching, and/or variables. In this example, a given dialogue flow 234 with a canonical form input of “ask math question” may include a next step of “ask wolfram alpha,” which is specified via “do” as an action to be performed. This dialogue flow 234 may also, or instead, include a subflow for “ask wolfram alpha” that defines multiple next steps to perform, including generation of a query related to the canonical form input, execution of the query by calling a corresponding application programming interface (API), and the canonical form output “respond with result.”

To generate dialogue flows 234 from paths 232, dialogue flow generator 218 may initially generate a separate dialogue flow 234 for each path 232. Thus, each initially generated dialogue flow 234 may include a linear sequence of steps for performing a certain task and/or handling a certain scenario. After paths 232 are converted into corresponding linear dialogue flows 234, dialogue flow generator 218 may combine two or more linear dialogue flows 234 into a branching dialogue flow 234.

For example, dialogue flow generator 218 may use rules and/or heuristics to determine that the same subsequence of steps (e.g., a subflow) is found in multiple dialogue flows 234. Dialogue flow generator 218 may combine these dialogue flows 234 into a single branching dialogue flow 234 that includes the subsequence of steps and multiple additional subsequences of steps that merge into the subsequence of steps and/or emerge from the subsequence of steps.

In another example, dialogue flow generator 218 may identify multiple dialogue flows 234 that share subsequences of a certain length, a minimum length, and/or a maximum length with the “default” dialogue flow 234 representing the most common or frequent path 232 within graph 220. Dialogue flow generator 218 may combine the identified dialogue flows 234 and the default dialogue flow 234 into a single dialogue flow 234 by adding portions of the identified dialogue flows 234 that deviate from the default dialogue flow 234 as subflows that lead into or branch out of the default dialogue flow 234.

In a third example, dialogue flow generator 218 may input the linear dialogue flows 234 into an LLM (or another type of generative model). Dialogue flow generator 218 may also provide, to the LLM, a prompt to combine the linear dialogue flows 234 into one or more nonlinear dialogue flows 234, instructions for combining linear dialogue flows 234 into nonlinear dialogue flows 234 (e.g., operators to include in the nonlinear dialogue flows 234, rules or heuristics for merging the linear dialogue flows 234, etc.), and/or examples of linear dialogue flows 234 that have been combined into corresponding nonlinear dialogue flows 234. Dialogue engine 124 may then receive the nonlinear dialogue flows 234 as output of the LLM and/or generative model.

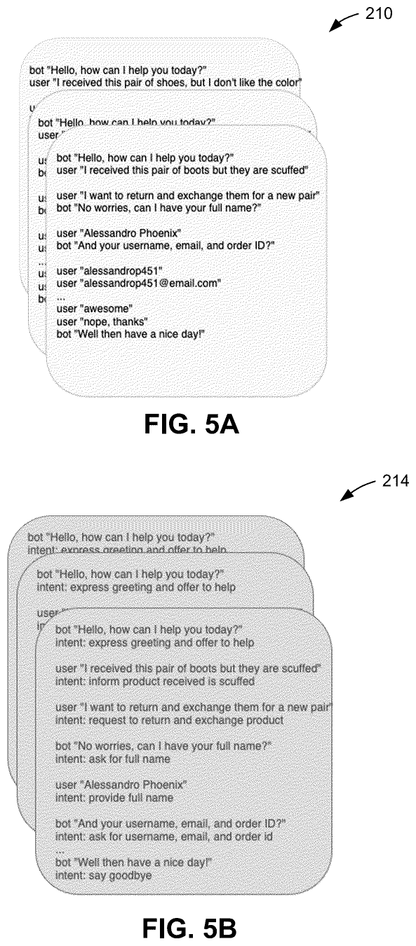

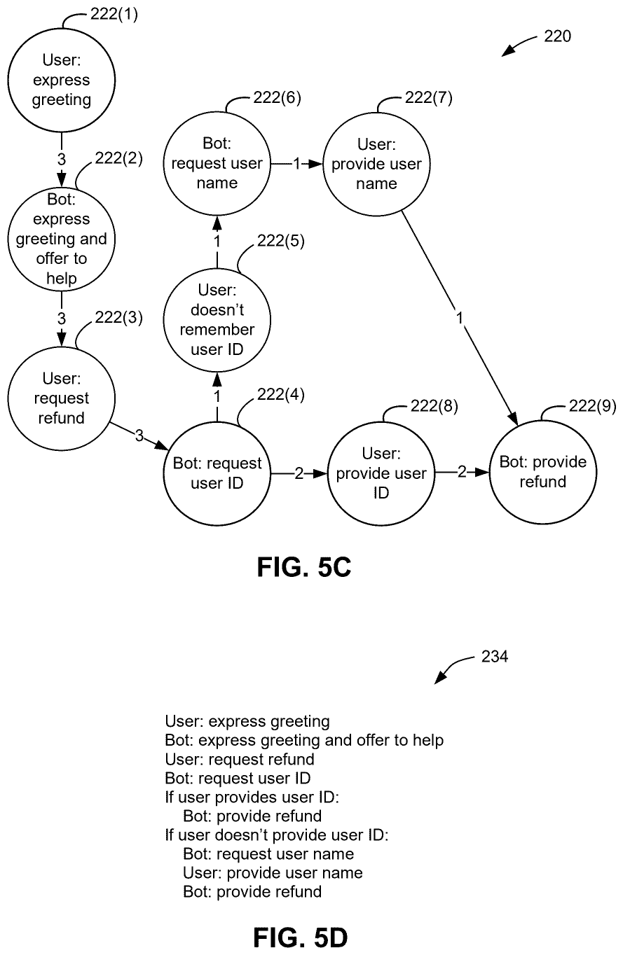

In one or more embodiments, conversations 210, canonical forms 214, dialogue flows 234, and/or other data processed and/or generated by annotation engine 122 and/or dialogue engine 124 are represented using a formal (conversational or natural language) modeling language. The formal modeling language may include a programming language that requires a particular syntax defining combinations of symbols that are considered to be correctly structured statements or expressions. For example, the syntax of the formal modeling language may permit definitions of canonical forms 214 associated with conversations 210 and/or output generated by machine learning model 208; definitions of dialogue flows 234 and subflows; entities and variables; sequences of events; structured programming constructs such as if, for, and while constructs; flow branching; instructions to be executed; actions to be performed; and/or integration with language models. In at least one embodiment, the formal modeling language can be interpretable by users and/or by one or more machine learning models (e.g., machine learning model 208, generative models, multimodal LLMs, etc.). Examples of conversations 210, canonical forms 214, dialogue flows 234, and/or other data that is represented using the formal modeling language may be provided to machine learning model 208, annotation engine 122, path extractor 216, dialogue flow generator 218, and/or other models or components that can be used to annotate conversations 210 with canonical forms 214, generate dialogue flows 234, and/or generate other data that is represented using the formal modeling language. Use of a formal modeling language to generate and/or represent conversations 210, canonical forms 214, and/or dialogue flows 234 is described in further detail herein with respect to FIGS. 5A-5D.

FIG. 5A illustrates an example set of conversations 210 that can be annotated by annotation engine 122 of FIG. 1, according to at least one embodiment. As shown in FIG. 5A, each of conversations 210 includes a sequence of utterances, where each utterance is made by either a “user” or a “bot.” Conversations 210 may thus include transcripts of chats between users and chatbots that span various tasks, issues, digressions, domains, and/or scenarios.

FIG. 5B illustrates the example conversations 210 of FIG. 5A that have been annotated with canonical forms 214, according to at least one embodiment. As shown in FIG. 5B, conversations 210 have been updated so that each utterance is followed by a corresponding “intent.” To annotate conversations 210 with canonical forms 214, annotation engine 122 may input conversations 210 into machine learning model 208 after machine learning model 208 has been trained and/or fine-tuned using training data 200 that includes a smaller set of training conversations 202 and corresponding training canonical forms 204. In response to the inputted conversations 210, machine learning model 208 may output the same conversations 210, with individual utterances in each conversation annotated with the corresponding canonical forms 214.

FIG. 5C illustrates an example graph 220 that is constructed from canonical forms 214 of FIG. 5B, according to at least one embodiment. As shown in FIG. 5C, the example graph 220 includes various nodes 222(1)-222(9) and directed edges (e.g., edges 224) between pairs of nodes 222. Each directed edge from a first node 222 to a second node 222 is associated with a weight that represents the frequency with which a first canonical form represented by the first node 222 is followed by a second canonical form represented by the second node 222 within the annotated conversations 210 of FIG. 5B.

More specifically, the example graph 220 includes a starting node 222(1) that corresponds to a starting point for some or all conversations 210 and represents a canonical form of “User: express greeting.” A first directed edge with a weight of 3 connects node 222(1) to node 222(2), which represents a canonical form of “Bot: express greeting and offer to help.” This first directed edge indicates that three conversations 210 include a message with the “User: express greeting” canonical form followed by a message with the “Bot: express greeting and offer to help” canonical form.

A second directed edge with a weight of 3 connects node 222(2) to node 222(3), which represents a canonical form of “User: request refund.” This second directed edge indicates that three conversations 210 include a message with the “Bot: express greeting and offer to help” canonical form followed by a message with the “User: request refund” canonical form.

A third directed edge with a weight of 3 connects node 222(3) to node 222(4), which represents a canonical form of “Bot: request user ID.” This third directed edge indicates that three conversations 210 include a message with the “User: request refund” canonical form followed by a message with the “Bot: request user ID” canonical form.

A fourth directed edge with a weight of 1 connects node 222(4) to node 222(5), which represents a canonical form of “User: doesn't remember user ID.” This fourth directed edge indicates that one conversation includes a message with the “Bot: request user ID” canonical form followed by a message with the “User: doesn't remember user ID” canonical form.

A fifth directed edge with a weight of 2 connects node 222(4) to node 222(8), which has a canonical form of “User: provide user ID.” The fifth directed edge indicates that two conversations 210 include a message with the “Bot: request user ID” canonical form followed by a message with the “User: provide user ID” canonical form. Because node 222(4) includes two outgoing edges (i.e., the fourth and fifth directed edges), node 224(4) represents a branch point in conversations 210.

A sixth directed edge with a weight of 2 connects node 222(8) to node 222(9), which represents a canonical form of “Bot: provide refund.” This sixth directed edge indicates that two conversations 210 include a message with the “User: provide user ID” canonical form followed by a message with the “Bot: provide refund” canonical form. Because node 222(9) does not have any outgoing edges, node 222(9) is an ending node that corresponds to an ending point for some or all conversations 210.

A seventh directed edge with a weight of 1 connects node 222(5) to node 222(6), which represents a canonical form of “Bot: request user name.” This seventh directed edge indicates that one conversation includes a message with the “User: doesn't remember user ID” canonical form followed by a message with the “Bot: request user name” canonical form.

An eighth directed edge with a weight of 1 connects node 222(6) to node 222(7), which represents a canonical form of “User: provide user name.” This eighth directed edge indicates that one conversation includes a message with the “Bot: request user name” canonical form followed by a message with the “User: provide user name” canonical form.

A ninth directed edge with a weight of 1 connects node 222(7) to the ending node 222(9). This ninth directed edge indicates that one conversation includes a message with the “User: provide user name” canonical form followed by a message with the “Bot: provide refund” canonical form.

The example graph 220 of FIG. 5C thus includes two paths from the starting node 222(1) to the ending node 222(9). A first path includes nodes 222(1), 222(2), 222(3), 222(4), 222(8), and 222(9). A second path includes nodes 222(1), 222(2), 222(3), 222(4), 222(5), 222(6), 222(7), and 222(9). Because weights of edges along the first path are higher than weights of edges along the second path, the first path may correspond to a “default” path from the starting point represented by the starting node 222(1) to the ending point represented by the ending node 222(9), and the second path may correspond to an “alternative” path from the starting point to the ending point.

FIG. 5D illustrates an example dialogue flow 234 that can be generated from graph 220 of FIG. 5C, according to at least one embodiment. This example dialogue flow 234 begins with a sequence of four canonical forms 214 represented by nodes 222(1)-222(4) of graph 220. The sequence of four canonical forms 214 is followed by a first conditional statement of “When user provides user ID” corresponding to node 222(8) and a canonical form represented by node 222(9). This example dialogue flow 234 additionally includes a second conditional statement of “When user doesn't provide user ID” corresponding to node 222(5) followed by a sequence of three canonical forms 214 represented by nodes 222(6), 222(7), and 222(9).

Dialogue flow 234 thus corresponds to a nonlinear dialogue flow that includes both paths from the starting node 222(1) to the ending node 222(9) in graph 220. To generate dialogue flow 234, an initial portion of graph 220 that is shared by both paths (e.g., nodes 222(1)-222(4)) may be converted into a corresponding sequence of canonical forms 214. Branching from node 222(4) to nodes 222(5) and 222(8) may be denoted by converting canonical forms 214 represented by nodes 222(5) and 222(8) into conditions that evaluate to true or false. Each condition is additionally followed by a sequence of one or more canonical forms represented by additional nodes 222(5), 222(6), 222(7), 222(8), and 222(9) in the corresponding branches.

In one or more embodiments, the example conversations 210, canonical forms 214, graph 220, and/or dialogue flow 234 of FIGS. 5A-5D are specified using a formal modeling language. The syntax of the formal modeling language may be used to define canonical forms 214, dialogue flow 234 and/or subflows of dialogue flow 234, entities (e.g., users, bots, etc.) and variables (e.g., user IDs, user names, account numbers, etc.), sequences of events (e.g., sequences of canonical forms, actions, etc. for performing various tasks), structured programming constructs (e.g., if, for, while, etc.), flow branching (e.g., using if, else if, when, else when, etc.), actions (e.g., execution of instructions), and/or integration with language models.

Returning to the discussion of FIG. 2, execution engine 126 incorporates dialogue flows 234 from dialogue flow generator 218 into various environments and/or use cases. First, execution engine 126 may use one or more dialogue flows 234 in runtimes 242 for chatbots and/or other conversation-based environments. For example, execution engine 126 may use one or more dialogue flows 234 to guide the generation of messages by chatbots, virtual assistants, virtual characters, agents, representatives, technicians, and/or other entities during interactions between the entities and users.

In some embodiments, execution engine 126 uses one or more dialogue flows 234 in conjunction with a language model (e.g., an LLM) to control the behavior of chatbots and/or other entities within runtimes 242. More specifically, execution engine 126 may use one or more dialogue flows 234 at the ingress to a language model to control, based on user input (e.g., a message from a user) and/or additional context, whether and/or how the language model is used and/or what actions are taken. Execution engine 126 may also, or instead, use one or more dialogue flows 234 at the egress of a language model to validate or otherwise control the output of the language model.

For example, execution engine 126 may use one or more dialogue flows 234 to cause chatbots to engage in and/or avoid discussing certain topics, such as to avoid providing financial advice or to avoid discussing subjects unrelated to a particular entity. As another example, one or more dialogue flows 234 may be used to cause a language model to follow a certain path 232, such as a path for authenticating a user. As another example, one or more dialogue flows 234 may be used for fact checking, such as to check output of a language model against information obtained by querying a knowledge base and/or a search engine (e.g., by comparing an output against a factual document, such as a user guide or a product specification document). As another example, one or more dialogue flows 234 may be used to check programming code generated by a language model, such as testing that the programming code can be executed successfully. As another example, one or more dialogue flows 234 may be used to provide additional context to a language model, such as providing instructions for a task associated with user input and/or providing hints associated with an intent of the user. As another example, one or more dialogue flows 234 may be used to constrain a language model to generate certain types of outputs, such as to respond to questions in a particular manner. As another example, one or more dialogue flows 234 may be used to execute one or more actions and/or make one or more API calls and (optionally) to use results of the action(s) and/or API calls to improve an output of a language model, such as calling a computational knowledge engine that performs mathematical computations to generate a result that can be included in, or used to improve, an output of a language model. As another example, one or more dialogue flows 234 may be used to control the style of output generated by a language model, such as to control a personality of output generated by the language model (e.g., by providing example dialogue, or example textual outputs, as part of a prompt to the language model, in order to provide examples of a format, style, character, or emotion desired for responses from the dialogue system). As another example, one or more dialogue flows 234 may be used to provide natural language instructions to a language model, such as to provide natural language instructions to an instruction-tuned LLM. As another example, one or more dialogue flows 234 may be used to provide a deny list of certain words and/or phrases that cannot be included in output of a language model. As another example, one or more dialogue flows 234 may be used to prevent prompt injection, such as to prevent a user from hijacking a prompt input into a language model. As yet another example, one or more dialogue flows 234 may be used to control a language model to format outputs according to a particular format, such as the JSON (JavaScript Object Notation) format.

In at least one embodiment, runtimes 242 are executed based on configuration information that includes definitions of canonical form inputs, canonical form outputs, and/or dialogue flows 234. This configuration information may be provided to execution engine 126 in any technically feasible manner. For example, in at least one embodiment, execution engine 126 or another application may provide a user interface (UI) (e.g., a web-based UI) and/or an API for specifying configuration information; import and/or customize configuration information; and/or select to use and/or customize canonical form inputs, canonical form outputs, and/or dialogue flows 234. As another example, configuration information may be included in a library that is integrated into an application that includes execution engine 126.

In some embodiments, execution engine 126 converts a user input (e.g., a chat message from a user) into a canonical form input by (1) determining one or more most similar example user inputs in the canonical form input definitions and associated canonical form inputs; and (2) prompting a language model to generate the canonical form input using a few-shot prompt that includes the most similar example user inputs, the corresponding canonical form inputs, and the current conversation (e.g., the dialogue history) with the user. More specifically, execution engine 126 may determine the most similar example user input(s) by generating an embedding of the user input in a semantic or latent space (e.g., by inputting the user input into a sentence transformer or other trained machine learning model that outputs the embedding as a vector), and then comparing the embedding of the user input to embeddings of example user inputs in the canonical form input definitions in the same semantic or latent space (e.g. according to a cosine similarity, Euclidean distance, and/or another distance metric) to determine one or more similar example user inputs whose embeddings are closest to the embedding of the user input. Execution engine 126 may also generate a few-shot prompt (e.g., in the syntax of the formal modeling language) that includes the similar example user inputs, corresponding predefined canonical form inputs, and/or the current conversation. Execution engine 126 may input the few-shot prompt into the language model (e.g., a p-tuned LLM), which outputs a canonical form input in response.

It should be understood that the canonical form input generated by the language model may, or may not, exactly match one of the canonical form inputs defined in the configuration information. For example, a user input of “How are you doing?” may be matched to the most similar example user inputs of (1) “hi,” “hello,” and “hey” that are associated with the “express greeting” canonical form input. In such a case, execution engine 126 may prompt the language model to generate a canonical form input using a few-shot prompt that includes the most similar example user inputs, the associated canonical form inputs, and the current conversation with the user. In turn, the language model may respond with a canonical form input that is different from the canonical form inputs defined in the configuration information. For example, the language model may output “express greeting question” as the canonical form input, which is different from the canonical form input of “express greeting” in the canonical form input definitions. In at least one embodiment, generated canonical form inputs and/or outputs that are different from predefined canonical form inputs and/or outputs may also be added to configuration information that includes the predefined canonical form inputs and/or outputs via a managed process, in which a user is permitted to select which canonical form inputs and/or outputs to add to the configuration information. For example, if a user determines that the canonical form input “express greeting question” is sufficiently common, then the user may add the canonical form input “express greeting question” to the configuration along with an associated example user input “How are you doing?”

In some embodiments, where there is no direct match for a canonical form, the closest canonical form (e.g., in the latent or semantic space) may be selected, and the dialogue flow associated with this canonical form may be used. Because the dialogue flow might not directly align with the current user input, a language model (e.g., an LLM) may be used to determine an appropriate response from a prompt generated using the user input, the history of the conversation, the closest canonical forms and related dialogue flows 234 (e.g., expressed in the formal modeling language, which may include example bot outputs corresponding to those flows, and/or other example bot outputs), and/or any additional information (e.g., data pulled from one or more API calls, such as to one or more third party services). The language model may process this generated prompt to output a natural language response that aligns well with desired dialogue flows 234 and outputs associated with similar canonical forms (or more generally, with similar user inputs/messages). In such embodiments, where the canonical form matches a predefined canonical form, a corresponding dialogue flow 234 associated with the matched canonical form may be used. If this dialogue flow 234 does not require interaction with the language model, the language model may be omitted, and one or more next steps in this dialogue flow 234 may be executed. If this dialogue flow 234 includes using the language model, a prompt may be generated for the language model using (for example) a predefined prompt style associated with this dialogue flow 234.

In further examples, execution engine 126 matches a canonical form input to a corresponding dialogue flow 234 that can be applied in one or more runtimes 242 to control the output of a language model. In at least one embodiment, execution engine 126 determines whether any dialogue flow 234 includes a canonical form input that matches (exactly or within a threshold similarity) the canonical form input into which a user input is converted. As used herein, matching within a threshold similarity can be determined in any technically feasible manner, such as based on a distance between embeddings, via fuzzy matching, etc. If no dialogue flow 234 includes a canonical form input that matches the canonical form input, execution engine 126 may generate a new dialogue flow by (1) determining one or more most similar canonical form inputs from existing dialogue flows 234; and (2) prompting the language model to generate the new dialogue flow using a few-shot prompt that includes the most similar canonical form inputs, the existing dialogue flows 234, and/or the current conversation with the user.

In at least one embodiment, execution engine 126 prompts the language model to generate the new dialogue flow in a similar manner as that used to generate a canonical form input, described above, except execution engine 126 can (1) compare embeddings of the canonical form input to embeddings of canonical form inputs in existing dialogue flows 234 to determine the most similar canonical form inputs; and (2) generate a few-shot prompt for the language model that includes the most similar canonical form inputs, dialogue flows 234 with the most similar canonical form inputs, and/or the current conversation with the user. Similar to the discussion above with respect to the canonical form input, given the few-shot prompt, the language model may respond with a new dialogue flow that is different from dialogue flows 234. In at least one other embodiment, execution engine 126 generates the new dialogue flow by inputting the canonical form input (and optionally context, such a history of the current conversation) into a trained machine learning model, such as a p-tuned LLM, that was trained to convert input text into new dialogue flows.

Given a dialogue flow that is matched to a canonical form input and/or a new dialogue flow that is generated from a canonical form input, execution engine 126 executes the matching or generated dialogue flow to generate an output. For example, execution engine 126 may execute one or more next steps included in the matching or generated dialogue flow by (1) determining a context, which can include, e.g., the last user input, a full history of the current conversation, information about an application such as application state variables, and/or environmental context such as in a multi-modal application; (2) optionally causing external tool(s) to execute based on the context and/or other parameters to generate an intermediate output; (3) matching (or matching within a threshold similarity) a canonical form output associated with the matching or generated dialogue flow to a predefined canonical form output, or if no such match exists, determining one or more most similar predefined canonical form outputs to the canonical form output associated with the matching or generated dialogue flow; and (4) outputting an example output associated with the matching predefined canonical form output, or prompting a language model to generate an output using a few-shot prompt that includes the most similar canonical form outputs, corresponding example outputs, and/or the current conversation with the user. Any technically feasible external tools may be used, and the particular external tool(s) that are used may be specified by the matching or generated dialogue flow. Examples of external tools that can be used in at least one embodiment include (but are not limited to) knowledge bases, computational knowledge engines, search engines, automation services, and/or libraries that include functions.

In at least one embodiment, the output includes a textual message that can be transmitted to a user in any technically feasible manner. For example, the output may include a textual message that execution engine 126 displays to a user via a UI. In another example, the output may include a textual message that is transmitted by execution engine 126 to an application from which the user input was received.

In some embodiments, execution engine 126 uses an additional dialogue flow to control outputs of the language model, such as to prevent undesired (e.g., factually inaccurate, biased, and/or harmful) outputs. In such cases, execution engine 126 may convert the output generated via execution of the matching or generated dialogue flow into a canonical form output, matching (exactly or within a threshold similarity) the canonical form output to a predefined dialogue flow or generating a new dialogue flow if the canonical form output does not match any predefined dialogue flow, and execute the matching or generated dialogue flow to generate an updated output.

Execution engine 126 also includes functionality to perform tests 244 using dialogue flows 234. For example, execution engine 126 may provide test environments for conversations, tasks, and/or scenarios that are conducted and/or guided using dialogue flows 234. These test environments may be used to determine the effectiveness of dialogue flows 234 in carrying out the conversations, tasks, and/or scenarios; identify potential issues associated with using dialogue flows 234 to guide conversations, tasks, and/or scenarios (e.g., missing steps, bugs, dead ends, etc.); and/or otherwise evaluate dialogue flows 234 in a non-production setting.

Execution engine 126 further supports modifications 246 to dialogue flows 234. For example, execution engine 126 may provide tools that can be used to view and/or interact with graph 220, paths 232, and/or dialogue flows 234. A developer, conversation designer, data scientist, and/or another user involved in creating and/or defining chatbots and/or dialogue flows 234 may use these tools to iterate over graph 220 and/or portions of graph 220; view paths 232 within graph 220 and/or extract paths 232 from graph 220; specify parameters that can be used to cluster canonical forms 214, summarize graph 220, filter infrequent paths 232 from graph 220, and/or extract paths 232 from graph 220; and/or make changes to graph 220, paths 232, and/or dialogue flows 234.

Execution engine 126 may also show and/or indicate the impact of modifications 246 on the corresponding conversations, tasks, and/or scenarios. Continuing with the above example, after a user modifies graph 220, one or more paths 232, and/or one or more dialogue flows 234, execution engine 126 may update visual representations of graph 220, paths 232, and/or dialogue flows 234 with highlighting, color coding, and/or other visual indicators of the location(s) of these modifications 246. Execution engine 126 may also, or instead, update the visual representations to include visual indicators of other location(s) that are affected by modifications 246 (e.g., locations in graph 220 that are no longer accessed due to modifications 246, steps or actions that are omitted or performed incorrectly due to modifications 246, etc.).

While the operation of annotation engine 122, dialogue engine 124, and execution engine 126 has been described with respect to generating dialogue flows 234 for use in guiding conversations, it will be appreciated that the functionality of annotation engine 122, dialogue engine 124, and execution engine 126 may be adapted to other types of sequential data. For example, annotation engine 122, dialogue engine 124, and execution engine 126 may be used to extract frequently occurring sequences of gestures, sounds, sentiments, movements, game-playing moves, navigation directions, and/or other types of interactions from a dataset of these interactions.

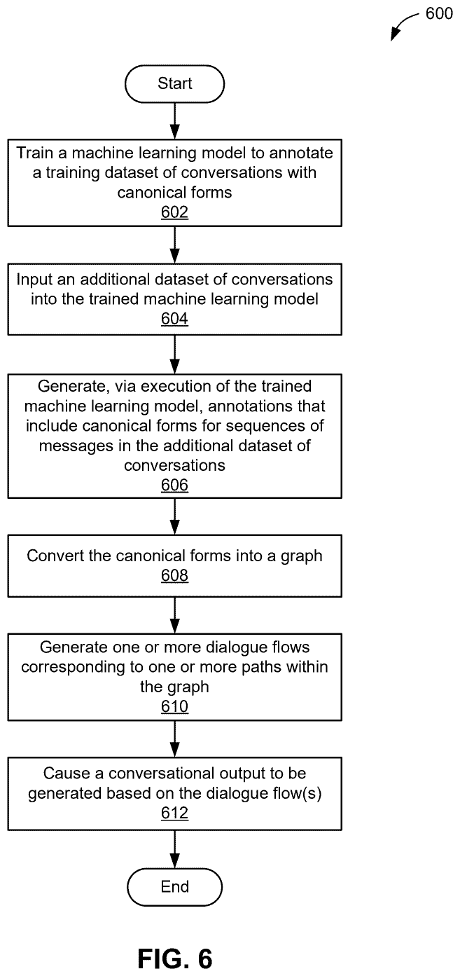

Now referring to FIG. 6, each block of method 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 600 is described, by simulated way of example, with respect to the systems of FIGS. 1-2. However, these methods may additionally or alternatively be executed by any one system, or any combination of systems, including, but not limited to, those described herein. Further, the operations in method 600 may be omitted, repeated, and/or performed in any order without departing from the scope of the present disclosure.

FIG. 6 illustrates a flow diagram of a method 600 for generating a dialogue flow, according to at least one embodiment. As shown in FIG. 6, method 600 begins with operation 602, in which annotation engine 122 trains a machine learning model to annotate a training dataset of conversations with canonical forms. For example, the machine learning model may include a pre-trained LLM, generative model, and/or another type of model that is capable of processing text-based input and/or generating text-based output. Annotation engine 122 may input each conversation in the training dataset into the machine learning model and obtain, as corresponding training output of the machine learning model, predictions of canonical forms for individual messages in the conversation. Annotation engine 122 may compute one or more losses between the training output and the corresponding “ground truth” canonical forms for the messages. Annotation engine 122 may then update parameters of the machine learning model in a way that reduces the loss(es), so that the machine learning model learns to annotate conversations with the corresponding canonical forms.

In operation 604, annotation engine 122 inputs an additional dataset of conversations into the trained machine learning model. For example, annotation engine 122 may input conversations involving users, chatbots, agents, representatives, technicians, virtual characters, and/or other entities into the trained machine learning model.

In operation 606, annotation engine 122 generates, via execution of the trained machine learning model, annotations that include canonical forms for sequences of messages in the additional dataset of conversations. For example, annotation engine 122 may receive, in response to each inputted conversation, output that includes the sequence of messages in the inputted conversation, where each message has been annotated with a corresponding canonical form. Annotation engine 122 may also, or instead, receive output that includes a sequence of canonical forms corresponding to the sequence of messages in the inputted conversation.

In operation 608, dialogue engine 124 converts the canonical forms into a graph. For example, dialogue engine 124 may create nodes that represent canonical forms of messages in the additional dataset of conversations. Dialogue engine 124 may also create a directed edge from a first node to a second node when a first canonical form represented by the first node is followed by a second canonical form represented by the second node in one or more of the conversations. Dialogue engine 124 may additionally assign a weight to each edge indicating the frequency with which the transition between the corresponding canonical forms occurs within the additional dataset of conversations. Dialogue engine 124 may further simplify the graph by clustering the nodes, filtering nodes and/or edges associated with low edge weights from the graph, summarizing the graph, and/or using other techniques.

In operation 610, dialogue engine 124 generates one or more dialogue flows corresponding to one or more paths within the graph. For example, dialogue engine 124 may use path analysis techniques, machine learning models, and/or other techniques to extract one or more “default” paths with the highest edge weights from the graph. Dialogue engine 124 may also extract paths that branch off of or deviate from a given default path as alternative paths that can be used to resolve issues, carry out different tasks, perform the same task as the default path in a different way, and/or handle diversions from the default path.

In operation 612, execution engine 126 causes a conversational output to be generated based on the dialogue flow(s). For example, execution engine 126 may incorporate the dialogue flow(s) into a runtime and/or test environment for a chatbot (or another entity involved in a conversation). During a conversation between the chatbot and a user, each message from the user may be matched to a canonical form by (1) determining one or more most similar example user inputs and associated canonical form inputs; and (2) prompting a language model (and/or another type of machine learning model) to generate the canonical form input using a few-shot prompt that includes the most similar example user inputs, the corresponding canonical form inputs, and/or the current conversation with the user. The canonical form may then be matched to a corresponding step within a dialogue flow generated in operation 610. The language model and/or another type of machine learning model may also be used to generate the conversational output as a response to the message based on a context that includes (but is not limited to) the message, a full history of the current conversation, information about an application such as application state variables, and/or environmental context such as in a multi-modal application. Execution engine 126 may continue using the dialogue flow(s) to process user messages and generate responses to the user messages, thereby guiding conversations between the users and the chatbot across various tasks, scenarios, and/or domains.

In sum, the disclosed techniques use a machine learning model, such as a large language model (LLM) and/or generative model, to automatically create dialogue flows for various types of conversation-based tasks and/or domains. The machine learning model is fine-tuned using a small set of conversations that have been manually annotated with canonical forms for messages from both users and chatbots. These canonical forms can include (but are not limited to) summarizations, short descriptions, and/or intent definitions related to messages in the conversations and/or actions performed in association with the messages. After fine-tuning is complete, the machine learning model is capable of generalizing to other types of tasks and/or domains.

More specifically, the fine-tuned machine learning model is used to annotate a larger dataset of conversations with the corresponding canonical forms. For example, the fine-tuned machine learning model may be used to convert a sequence of messages within each conversation into a corresponding sequence of canonical forms. The fine-tuned machine learning model may also, or instead, be used to append a canonical form to the end of each message within the sequence.

Next, a graph is constructed from the annotated conversations. Within the graph, nodes represent canonical forms, and directed edges represent orderings of messages annotated with the canonical forms within the conversations. Each edge may also be associated with a weight representing a frequency of occurrence and/or another measure of relative importance or prominence.

Various graph analysis techniques may then be used to extract paths representing different types of dialogue flows. For example, a path that includes edges with the highest weights may be used as a “default” dialogue flow for a particular type of task. Additional paths that branch off the default path may be used as dialogue flows for other types of tasks, issue resolution, digressions, and/or other scenarios. The extracted dialogue flows may then be incorporated into chatbot runtimes, tested, and/or refined.

One technical advantage of the disclosed techniques relative to prior approaches is the ability to automatically generate dialogue flows from large sets of unlabeled conversations. The disclosed techniques are thus more efficient and less resource-intensive than conventional approaches that involve manual generation of dialogue flows and/or labels for process mining dialogue flows. Another technical advantage of the disclosed techniques is the ability to extract, from the unlabeled conversations, various paths that can be used to perform different types of tasks and/or address various issues associated with the tasks. Consequently, the disclosed techniques can be used to generate more flexible and comprehensive dialogue flows than existing approaches that are limited in the ability to generate dialogue flows for different domains and/or scenarios.

### Inference and Training Logic

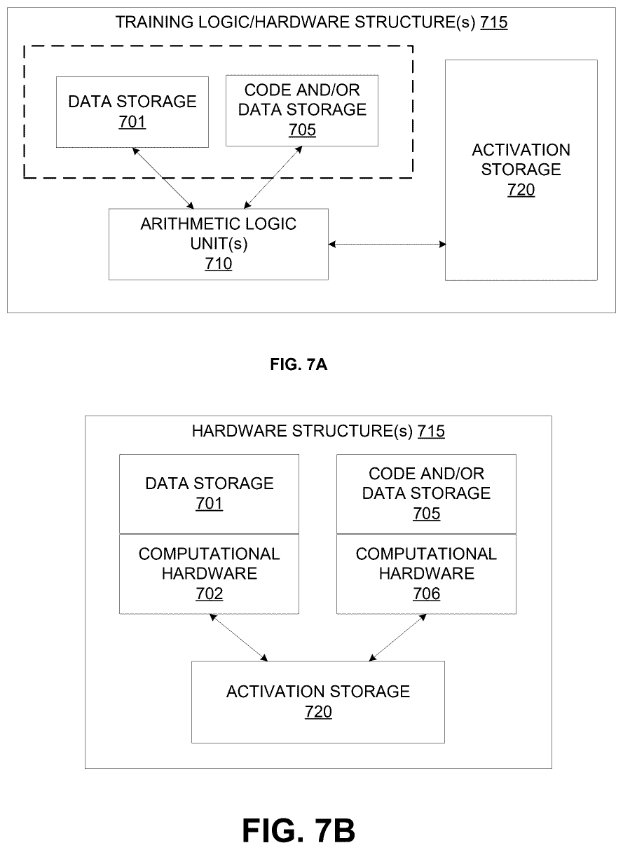

FIG. 7A illustrates inference and/or training logic 715 used to perform inferencing and/or training operations associated with one or more embodiments. Details regarding inference and/or training logic 715 are provided herein in conjunction with at least FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a coprocessor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

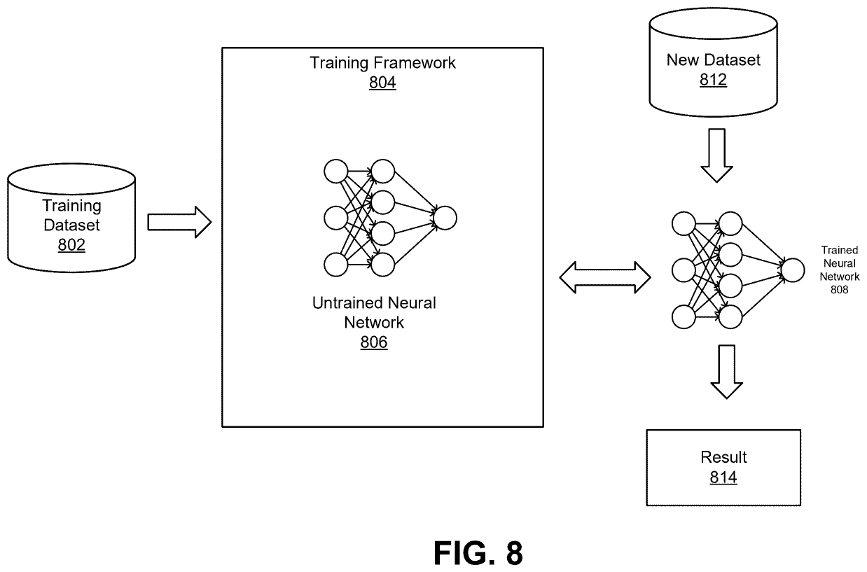

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

In at least one embodiment, training framework 804 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

1. In some embodiments, a method comprises inputting a conversation, including a sequence of messages, into a machine learning model, generating, via execution of the machine learning model, a plurality of annotations comprising a plurality of canonical forms corresponding to the sequence of messages, individual canonical forms including a constrained semantic representation of a respective message included in the sequence of messages, generating one or more dialogue flows using the plurality of canonical forms, and causing a conversational output to be generated based at least on the one or more dialogue flows.

2. The method of clause 1, wherein the machine learning model is trained based at least on a plurality of conversations and a second plurality of canonical forms for additional sequences of messages included in the plurality of conversations.

3. The method of clauses 1 or 2, wherein the generating the one or more dialogue flows comprises converting the plurality of canonical forms into a graph, and extracting one or more paths corresponding to the one or more dialogue flows from the graph.

4. The method of any of clauses 1-3, wherein the graph comprises a plurality of nodes representing the plurality of canonical forms, a plurality of edges representing orderings of the canonical forms within at least one of the conversation or one or more other conversations processed using the machine learning model, and a plurality of weights that are associated with the plurality of edges and represent frequencies of the corresponding orderings within at least one of the conversation or the one or more other conversations.

5. The method of any of clauses 1-4, wherein the extracting the one or more paths comprises extracting a default path corresponding to a most frequent dialogue flow from the graph.

6. The method of any of clauses 1-5, wherein the extracting the one or more paths further comprises extracting a branching path corresponding to an alternative dialogue flow that deviates from the most frequent dialogue flow from the graph.

7. The method of any of clauses 1-6, wherein the causing the conversational output to be generated comprises generating a prompt that includes the one or more dialogue flows and at least a portion of a current conversation, and processing the prompt using a language model to generate the conversational output.

8. The method of any of clauses 1-7, wherein the conversation includes a first set of messages from one or more users and a second set of messages from one or more chatbots.

9. The method of any of clauses 1-8, wherein the machine learning model includes a large language model (LLM).

10. The method of any of clauses 1-9, wherein the plurality of canonical forms and the one or more dialogue flows are specified in a formal modeling language.

11. In some embodiments, a processor comprises one or more processing units to perform operations comprising inputting a plurality of conversations into a machine learning model, generating, based at least on the machine learning model processing the plurality of conversations, a plurality of annotations comprising a plurality of constrained semantic representations for respective messages of sequences of messages included in the plurality of conversations, generating one or more dialogue flows using the plurality of constrained semantic representations, and causing a conversational output to be generated based at least on the one or more dialogue flows.

12. The processor of clause 11, wherein the machine learning model, prior to deployment, is fine-tuned based on a second plurality of conversations and a second plurality of constrained semantic representations for additional sequences of messages included in the second plurality of conversations.

13. The processor of clauses 11 or 12, wherein the generating the one or more dialogue flows comprises generating a plurality of clustered canonical forms from the plurality of constrained semantic representations, converting the plurality of clustered canonical forms into a graph, and extracting one or more paths corresponding to the one or more dialogue flows from the graph.

14. The processor of any of clauses 11-13, wherein the graph comprises a plurality of nodes representing the plurality of clustered canonical forms, a plurality of edges representing orderings of the plurality of clustered canonical forms within the plurality of conversations.

15. The processor of any of clauses 11-14, wherein the extracting the one or more paths comprises extracting a default path corresponding to a most frequent dialogue flow, and extracting a branching path corresponding to an alternative dialogue flow that deviates from the most frequent dialogue flow.

16. The processor of any of clauses 11-15, wherein the causing the conversational output to be generated comprises generating an embedding of a canonical form associated with the one or more dialogue flows, determining one or more canonical forms based at least on the embedding and one or more embeddings of one or more predefined canonical forms, generating a prompt that includes the one or more canonical forms, one or more example outputs associated with the one or more canonical forms, and at least a portion of a current conversation, and inputting the prompt into a language model to generate the conversational output.

17. The processor of any of clauses 11-16, wherein the machine learning model comprises at least one of a generative model or a large language model (LLM).

18. The processor of any of clauses 11-17, wherein the one or more processors are comprised in at least one of a system for performing simulation operations, a system for performing digital twin operations, a system for performing collaborative content creation for 3D assets, a system for performing one or more deep learning operations, a system implemented using an edge device, a system for generating or presenting at least one of virtual reality content, augmented reality content, or mixed reality content, a system implemented using a robot, a system for performing one or more conversational AI operations, a system implemented using one or more large language models (LLMs), a system for generating synthetic data, a system for performing one or more generative AI operations, a system incorporating one or more virtual machines (VMs), a system implemented at least partially in a data center, or a system implemented at least partially using cloud computing resources.

19. In some embodiments, a system comprises one or more processing units to generate a dialogue policy using sequences of intents corresponding to a plurality of conversations, the sequences of intents determined based at least on a large language model (LLM) processing data corresponding to the plurality of conversations and associating intents from the sequences of intents with individual messages includes in the plurality of conversations.

20. The system of clause 19, wherein the system is comprised in at least one of a system for performing simulation operations, a system for performing digital twin operations, a system for performing collaborative content creation for 3D assets, a system for performing one or more deep learning operations, a system implemented using an edge device, a system for generating or presenting at least one of virtual reality content, augmented reality content, or mixed reality content, a system implemented using a robot, a system for performing one or more conversational AI operations, a system implemented using one or more large language models (LLMs), a system for generating synthetic data, a system for performing one or more generative AI operations, a system incorporating one or more virtual machines (VMs), a system implemented at least partially in a data center, or a system implemented at least partially using cloud computing resources.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
inputting a conversation, including a sequence of messages, into a machine learning model;
generating, via execution of the machine learning model, a plurality of annotations comprising a plurality of canonical forms corresponding to the sequence of messages, individual canonical forms including a constrained semantic representation of a respective message included in the sequence of messages;
generating one or more dialogue flows using the plurality of canonical forms; and
causing a conversational output to be generated based at least on the one or more dialogue flows.

2. The method of claim 1, wherein the machine learning model is trained based at least on a plurality of conversations and a second plurality of canonical forms for additional sequences of messages included in the plurality of conversations.

3. The method of claim 1, wherein the generating the one or more dialogue flows comprises:
converting the plurality of canonical forms into a graph; and
extracting one or more paths corresponding to the one or more dialogue flows from the graph.

4. The method of claim 3, wherein the graph comprises a plurality of nodes representing the plurality of canonical forms, a plurality of edges representing orderings of the canonical forms within at least one of the conversation or one or more other conversations processed using the machine learning model, and a plurality of weights that are associated with the plurality of edges and represent frequencies of the corresponding orderings within at least one of the conversation or the one or more other conversations.

5. The method of claim 3, wherein the extracting the one or more paths comprises extracting a default path corresponding to a most frequent dialogue flow from the graph.

6. The method of claim 5, wherein the extracting the one or more paths further comprises extracting a branching path corresponding to an alternative dialogue flow that deviates from the most frequent dialogue flow from the graph.

7. The method of claim 1, wherein the causing the conversational output to be generated comprises:
generating a prompt that includes the one or more dialogue flows and at least a portion of a current conversation; and
processing the prompt using a language model to generate the conversational output.

8. The method of claim 1, wherein the conversation includes a first set of messages from one or more users and a second set of messages from one or more chatbots.

9. The method of claim 1, wherein the machine learning model includes a large language model (LLM).

10. The method of claim 1, wherein the plurality of canonical forms and the one or more dialogue flows are specified in a formal modeling language.

11. A processor comprising:
one or more processing units to perform operations comprising:
inputting a plurality of conversations into a machine learning model;
generating, based at least on the machine learning model processing the plurality of conversations, a plurality of annotations comprising a plurality of constrained semantic representations for respective messages of sequences of messages included in the plurality of conversations;
generating one or more dialogue flows using the plurality of constrained semantic representations; and
causing a conversational output to be generated based at least on the one or more dialogue flows.

12. The processor of claim 11, wherein the machine learning model, prior to deployment, is fine-tuned based on a second plurality of conversations and a second plurality of constrained semantic representations for additional sequences of messages included in the second plurality of conversations.

13. The processor of claim 11, wherein the generating the one or more dialogue flows comprises:
generating a plurality of clustered canonical forms from the plurality of constrained semantic representations;
converting the plurality of clustered canonical forms into a graph; and
extracting one or more paths corresponding to the one or more dialogue flows from the graph.

14. The processor of claim 13, wherein the graph comprises a plurality of nodes representing the plurality of clustered canonical forms, a plurality of edges representing orderings of the plurality of clustered canonical forms within the plurality of conversations.

15. The processor of claim 13, wherein the extracting the one or more paths comprises:
extracting a default path corresponding to a most frequent dialogue flow; and
extracting a branching path corresponding to an alternative dialogue flow that deviates from the most frequent dialogue flow.

16. The processor of claim 11, wherein the causing the conversational output to be generated comprises:
generating an embedding of a canonical form associated with the one or more dialogue flows;
determining one or more canonical forms based at least on the embedding and one or more embeddings of one or more predefined canonical forms;
generating a prompt that includes the one or more canonical forms, one or more example outputs associated with the one or more canonical forms, and at least a portion of a current conversation; and
inputting the prompt into a language model to generate the conversational output.

17. The processor of claim 16, wherein the machine learning model comprises at least one of a generative model or a large language model (LLM).

18. The processor of claim 11, wherein the one or more processors are comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system for generating synthetic data;
a system for performing one or more generative AI operations;
a system incorporating one or more virtual machines (VMs);
a system implemented at least partially in a data center; or
a system implemented at least partially using cloud computing resources.

19. A system comprising:
one or more processing units to generate a dialogue policy using sequences of intents corresponding to a plurality of conversations, the sequences of intents determined based at least on a large language model (LLM) processing data corresponding to the plurality of conversations and associating intents from the sequences of intents with individual messages includes in the plurality of conversations.

20. The system of claim 19, wherein the system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system for generating synthetic data;
a system for performing one or more generative AI operations;
a system incorporating one or more virtual machines (VMs);
a system implemented at least partially in a data center; or
a system implemented at least partially using cloud computing resources.
